(19) United States
(12) Patent Application Publication
(10) Pub. No.: US 2013/0310128 A1
(43) Pub. Date: Nov. 21, 2013

(54) INTERACTIVE GAME TO RECOGNIZE EMPLOYEES FOR GOOD PERFORMANCE

(71) Applicants: MARK REYES, Escondido, CA (US); JESSE CARL TAYLOR, III, San Diego, CA (US)

(72) Inventors: MARK REYES, Escondido, CA (US); JESSE CARL TAYLOR, III, San Diego, CA (US)

(73) Assignee: SONY CORPORATION

(21) Appl. No.: 13/475,317

(22) Filed: May 18, 2012

(51) Int. Cl. A63F 13/12

(52) U.S. Cl. 463/16; 463/42

(57) ABSTRACT

To recognize superior performance, an employee is nominated to participate in a web-hosted “closed” game in which the employee spins a game wheel listing prizes, and based on the spin and predetermined prize probabilities, wins a guaranteed prize. The prize can then be automatically sent to the employee.

### FIELD OF THE INVENTION

The present application relates generally to computer game show-like interactive games to recognize employees for good performance.

### BACKGROUND OF THE INVENTION

As understood herein, in a competitive labor market it is necessary to incentive top performers in creative and sensible ways. As also understood herein, an excellent way of doing so is to award prizes to individuals who have been recognized for their outstanding performance across their particular field of expertise.

### SUMMARY OF THE INVENTION

Accordingly, present principles provide a “closed-loop” system in which the allocation and distribution of prize “assets” is done automatically or with minimal assistance from an outside facilitator/administrator.

A method to recognize superior performance of an employee includes nominating an employee to participate in a web-hosted “closed” game in which the employee, by means of a computer, initiates an animated spin of a computer-displayed game wheel listing prizes. Based on the spin and predetermined prize probabilities, a prize is indicated using the game wheel.

In another aspect, a contestant computer includes a display and a processor configured to control the display to present a game wheel animated to rotate upon receipt of a spin signal. The game wheel includes plural regions, with each region representing a single prize that is unique to the other prizes in the other regions of the game wheel and with no prize being displayed in more than one region. Each region may be a pie-shaped wedge, and each region may have its own color unique from other colors in other regions of the game wheel.

If desired, the regions can be established automatically by accessing a computer database of available prizes and selecting items from the database. Prizes represented on the game wheel can be changed periodically randomly based on availability.

In examples, the game wheel includes a TV region which represents a TV, a game console region which represents a game console, and a phone region representing a phone. The game wheel further may include an e-book region representing an electronic book and a prize indicator. The prize indicator can be juxtaposed with the game wheel in a static position relative to the game wheel.

In another aspect, a computer has a processor and a display configured to be controlled by the processor to present a game wheel. The processor, responsive to a spin command, animates the wheel to appear to spin. A prize indicated by the wheel is indicated on the display indicated. Weights are established for each prize according to a respective value of each prize.

The prize can be indicated based on which region of the wheel stops under a prize indicator. Alternatively or in addition, the prize can be indicated by a message overlaid on the wheel. More valuable prizes may be given lower weights and less valuable prizes may given higher weights, meaning that less valuable prizes are more likely to be won than higher value prizes.

In example embodiments the computer is a player computer and a user of a host computer communicating with the player computer enters the spin command. Or, a user of the computer enters the spin command by an arcuate gesture in free space or applied against a touch sensitive surface communicating with the processor. In this latter case the processor animates the wheel to spin at a rate proportional to a speed of the arcuate gesture.

The above-mentioned weights can be used to establish an array of possible outcomes of spinning the wheel. A prize weighted at “N” is replicated to appear “N” times in the array, with a pseudo-random selection from the array being made to establish a prize that is won. If desired, the processor causes the wheel to stop spinning with a winning region indicated. The winning region can correspond to the selection from the array at a time from beginning spinning of the wheel that results in a spin period which is proportional to a speed of the spin.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram showing an example system in accordance with present principles;

FIG. 2 is a screen shot showing an example image of a game wheel;

FIG. 3 is a flow chart of example overall logic performed by the system;

FIG. 4 is a flow chart of example details of the logic;

FIG. 5 is a flow chart of further example details of the logic;

FIG. 6 is a screen shot showing an example image of a game wheel indicating a prize being won;

FIG. 7 is a screen shot showing an alternate 3D image of a game wheel in a game room; and

FIG. 8 is a flow chart of example logic for prize delivery.

### DETAILED DESCRIPTION OF THE PREFERRED EMBODIMENT

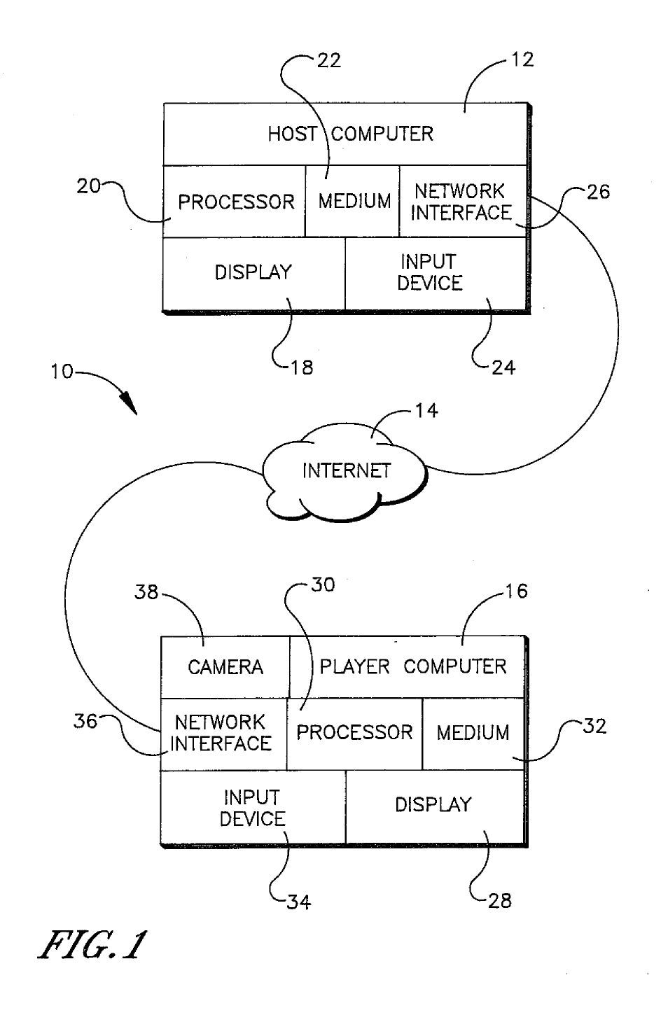

Referring initially to FIG. 1, a system 10 is shown in which a host computer 12 communicates over a network 14 with a player computer 16. The network 14 may be a local area network (LAN) or private company Intranet that may use portions of the Internet according to principles known in the art.

As shown, the host computer 12 may include a display 18 such as a high definition flat panel display controlled by a host processor 20 accessing a computer readable storage medium 22 such as disk-based or solid state storage. The medium 22 may be local memory used by the processor 20 to undertake present principles on the host side. The processor 20 may receive input from one or more user input devices 24 such as keyboards, keypads, mice, touch pads, touchscreens when the display 18 is so configured, etc. The host communicates with the player computer over the network 14 using a network interface 26 such as a wired or wireless modem.

The player computer 16 may include a display 28 such as a high definition flat panel display controlled by a player processor 30 accessing a computer readable storage medium 32 such as disk-based or solid state storage. In some embodiments the display 28 is integrated into a player computer that is established by, e.g., a tablet computer. In other implementations the display 28 is a large screen 3D display. The medium 32 may be local memory used by the processor 30 to undertake present principles on the player side. The processor 30 may receive input from one or more user input devices 34 such as keyboards, keypads, mice, touch pads, touchscreens when the display 28 is so configured, etc. The host communicates with the host computer over the network 14 using a network interface 36 such as a wired or wireless modem. Images of a user of the player computer 16 may be captured by a camera 38 on or nearby the player computer 16 and communicated to one or both of the processors 20, 30.

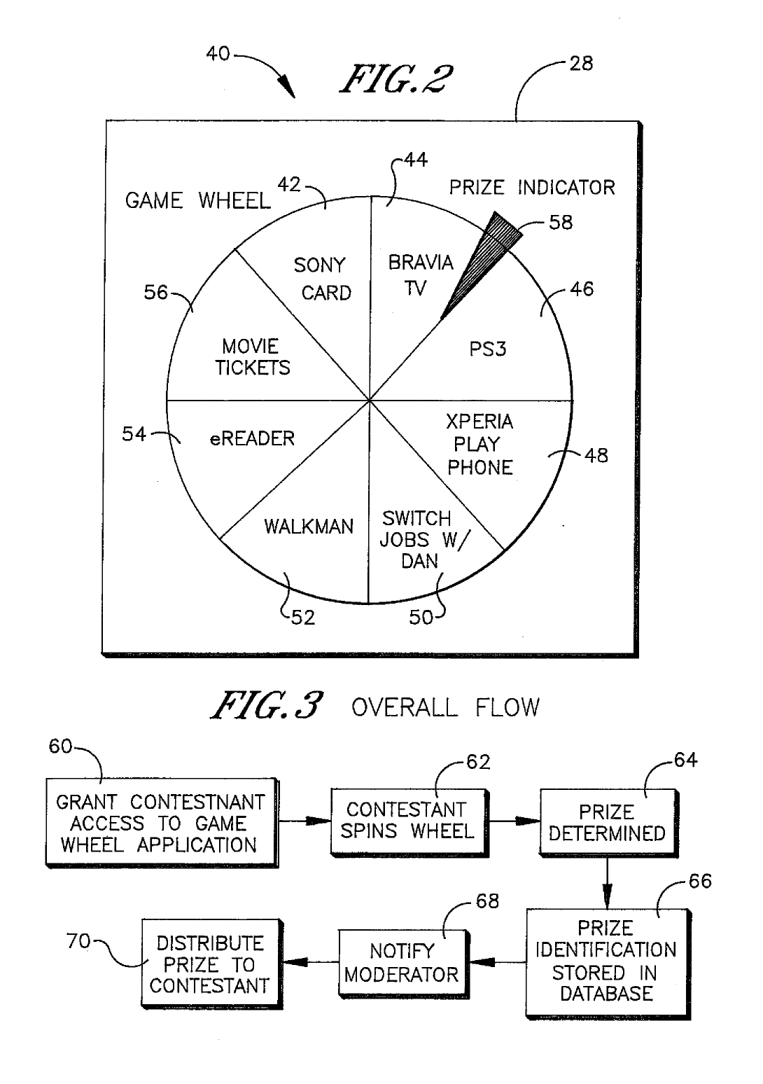

Before describing operation, FIG. 2 shows an example game wheel 40 that may be presented on the player computer display 28 according to logic below. In the example shown, the game wheel 40 is visually divided into multiple pie-shaped regions, with each region representing a single prize that is unique to the other prizes in the other regions and with no prize being displayed in more than one region. Each region may also have its own color unique from other colors in other regions. The regions are established by the host computer 12, either based on human input from the host input device 24 or by the host computer automatically accessing a computer database of available prizes, typically products of the company hosting the game wheel, and selecting items from the list based on, e.g., sales popularity. In the latter embodiment the host computer can change the prizes represented on the game wheel 40 randomly based on availability.

In the example embodiment shown, the game wheel 40 includes a “card” region 42 which represents a memory card or company gift card, and a TV region 44, which represents a TV made by the company. The game wheel 40 also includes a game console region 46 which represents a game console, e.g., Sony's Playstation 3 (trademark), and a phone region 48 representing a phone such as an “Xperia Play” phone. A “switch jobs” region 50 may be provided representing an opportunity to switch jobs, e.g., for a day with, e.g., the player's boss, and a portable player region 52 representing a portable audio player such as a Sony Walkman. An e-book region 54 can represent an electronic book and a movie tickets region 56 can represent free movie tickets. A prize indicator 58, in the embodiment shown, an arrow- or triangular-shaped object, may be presented in a static position on the game wheel 40.

With the above understanding in mind, attention is now directed to FIG. 3, in which at block 60 a contestant such as a successful employee is granted access to a game wheel application. In one embodiment, the contestant is nominated and upon being selected to play the game, in which a prize of some sort is guaranteed to be won, is notified, e.g., by social networking or email, of such, and is given login address and credentials. The contestant uses the player computer 16 to log in and is sent the requisite web application in, e.g., hypertext markup language/Flash language from the host computer 12.

Upon successful access by the player computer 16, the game wheel 40 of FIG. 2 is presented on the display 28 of the player computer. The player spins the wheel at block 62 according to description below, and at block 64 a prize is determined based on which region of the wheel “stops” under the prize indicator 58. The identification of the prize is stored at block 66 and the moderator (user of the host computer) and player are notified of the prize that is won at block 68. The prize is distributed to the player at block 70.

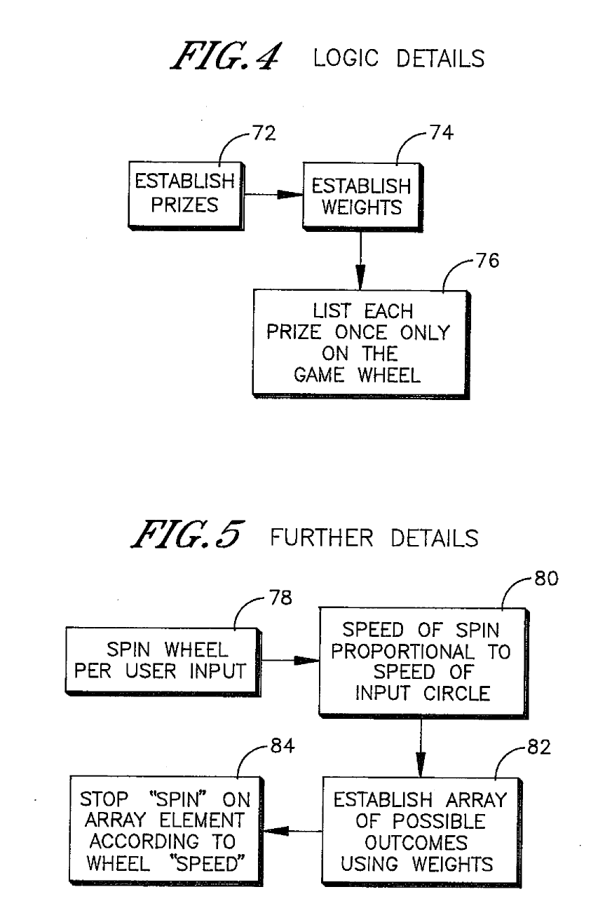

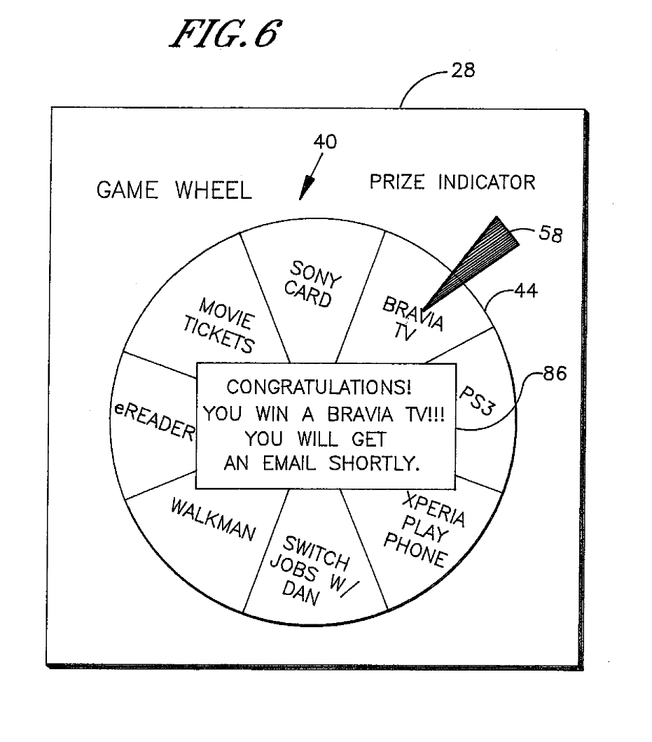

FIGS. 4 and 5 show additional logic that may be employed. Commencing at block 72 prizes are established for the game wheel as described above. At block 74 weights are established for each prize according to its value. More valuable prizes are given lower weights and less valuable prizes are given higher weights, meaning that less valuable prizes are more likely to be won than higher value prizes. These weights are entered into the host computer 12. At block 76, regardless of their weights, each prize is caused to be listed once and once only in a respective region of the game wheel.

Block 78 of FIG. 5 indicates that the game wheel 40 is animated to appear to spin (rotate) on the display 28 responsive to a spin signal. In one embodiment, the user of the host computer may select a spin selector element at the host computer to signal the player computer to animate the wheel to spin. In other embodiment, the user of the player computer spins the wheel by pressing a spin key, analogous to a slot machine spin key, or by circling his finger on a touch display such as a touch pad or touch-sensitive display 28. In the latter case, at block 80 the player processor 30 determines the speed of the user's finger in making the circling motion and animates the game wheel to spin at a speed proportional to the input user motion, faster rotation for a faster finger motion and slower rotation for a slower finger motion.

Also, block 82 indicates that ,in one embodiment, the prize weights established at block 74 are used to establish an array of possible outcomes of the spin using the weights, it being understood that other methods for providing a weighted outcome may be used. In this example, if a lower value prize is weighted at “4”, it is replicated to appear four times in the array, while a prize weighted “3” appears three times. A prize weighted “1” only appears once. A pseudo-random selection of the weighted array is then made of the prize that is “won” by the contestant, and the wheel stops spinning on the display 28 at block 84 on the region corresponding to the winning array element at the closest time (for the winning “region”) from the beginning of the spin that results in a spin period which is proportional to the speed of the spin as determined at block 78.

The result of this last step at block 84 is illustrated in FIG. 6, in which the wheel 40 has stopped spinning with the TV region 44 underneath the prize indicator 58, indicating that the contestant has won a TV. A congratulatory message 86 may be presented superimposed on the wheel 40 as shown, if desired.

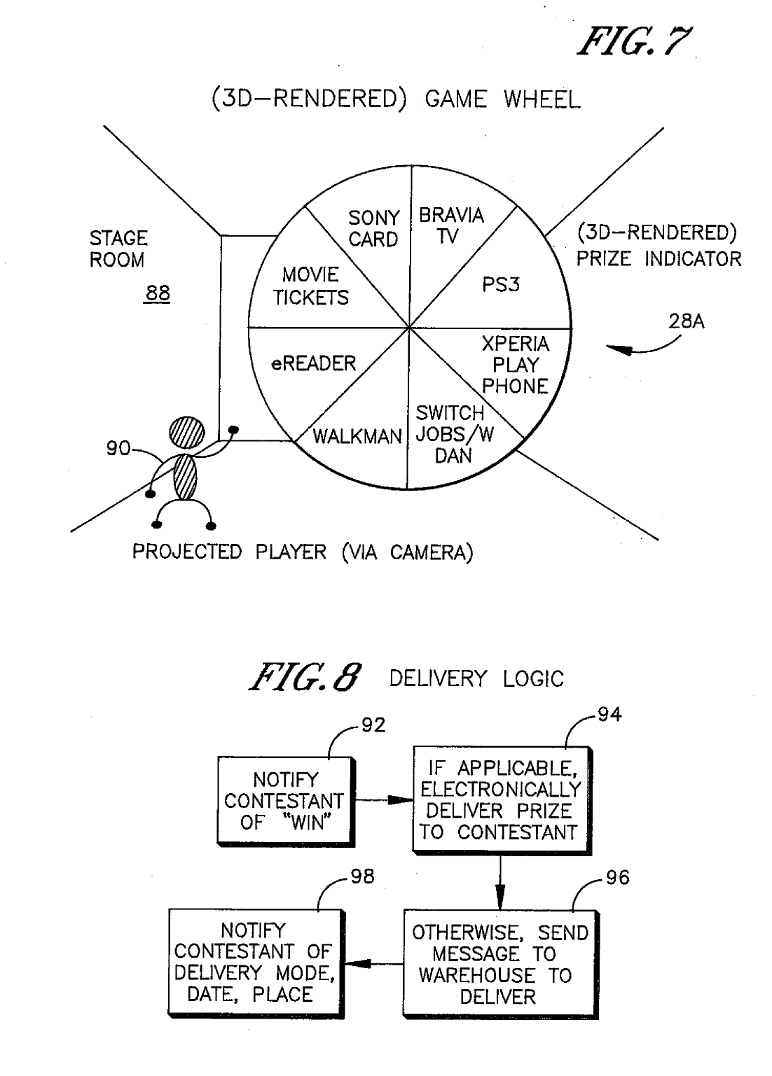

FIG. 7 illustrates an alternate embodiment in which the player computer display is established by a 3D display 28A in a stage room 88. A projection 90 of the player as imaged by the camera 38 may also be presented in 3D. Or, the player may appear personally in the room 88, in which case the player can make a circular gesture in free space which is captured by the camera 38 and interpreted as the “spin” command discussed above.

FIG. 8 shows that after a prize is won in the above-described game, at block 92 the contestant is notified of the win via, e.g., the message 86 in FIG. 6 and/or by email, social network, etc. At block 94, if applicable the prize is electronically delivered to the contestant. For example, if movie tickets or other prize (massage, car wash, etc.) requiring a paper voucher to redeem is won, the voucher can be emailed from the host computer 12 to the contestant's company email which is on file. Otherwise, at block 96 a message be sent automatically from the host computer 12, responsive to the spin results received from the player computer 16, to a warehouse at which the winning items may be located, instructing the warehouse, using an automated message if desired, to send the prize to the contestant's address of record with the company. At block 98 the contestant is notified of the delivery mode and delivery date of the prize.

Advertising agencies may also apply present principles as a new service outside of their normal means of print or web. Present principles offer a new landscape for game show concepts. It could be a subset of an actual game or be established as a new theme. A manufacturing company's retail stores as well as other organizations can leverage present principles to consumers through special promotions with the goal of attracting new business.

While the particular INTERACTIVE GAME TO RECOGNIZE EMPLOYEES FOR GOOD PERFORMANCE is herein shown and described in detail, it is to be understood that the subject matter which is encompassed by the present invention is limited only by the claims.

What is claimed is:

1. Contestant computer, comprising:
display;
processor configured to control the display to present a game wheel animated to rotate upon receipt of a spin signal, the game wheel including:
plural regions, with each region representing a single prize that is unique to the other prizes in the other regions of the game wheel and with no prize being displayed in more than one region.

2. The computer of claim 1, wherein each region is a pie-shaped wedge.

3. The computer of claim 1, wherein each region has its own color unique from other colors in other regions of the game wheel.

4. The computer of claim 1, wherein the regions are established automatically by accessing a computer database of available prizes and selecting items from the database.

5. The computer of claim 4, wherein prizes represented on the game wheel are changed periodically randomly based on availability.

6. The computer of claim 1, wherein the game wheel includes a TV region which represents a TV, a game console region which represents a game console, and a phone region representing a phone.

7. The computer of claim 6, wherein the game wheel further includes an e-book region representing an electronic book and a prize indicator.

8. The computer of claim 1, wherein the display further presents a prize indicator juxtaposed with the game wheel in a static position relative to the game wheel.

9. Computer comprising:
processor;
display configured to be controlled by the processor to present a game wheel;
the processor, responsive to a spin command, animating the wheel to appear to spin, a prize indicated by the wheel being indicated, weights being established for each prize according to a respective value of each prize.

10. The computer of claim 9, wherein the prize is indicated based on which region of the wheel stops under a prize indicator.

11. The computer of claim 9, wherein the prize is indicated by a message overlaid on the wheel.

12. The computer of claim 9, wherein more valuable prizes are given lower weights and less valuable prizes are given higher weights, meaning that less valuable prizes are more likely to be won than higher value prizes.

13. The computer of claim 9, wherein the computer is a player computer and a user of a host computer communicating with the player computer enters the spin command.

14. The computer of claim 9, wherein a user of the computer enters the spin command by an arcuate gesture in free space or applied against a touch sensitive surface communicating with the processor.

15. The computer of claim 14, wherein the processor animates the wheel to spin at a rate proportional to a speed of the arcuate gesture.

16. The computer of claim 12, wherein the weights are used to establish an array of possible outcomes of spinning the wheel, wherein a prize weighted at “N” is replicated to appear “N” times in the array, a pseudo-random selection from the array being made to establish a prize that is won.

17. The computer of claim 16, wherein the processor causes the wheel to stop spinning with a winning region indicated, the winning region corresponding to the selection from the array at a time from beginning spinning of the wheel that results in a spin period which is proportional to a speed of the spin.

18. Method to recognize superior performance, comprising:
nominating an employee to participate in a web-hosted “closed” game in which the employee, by means of a computer, initiates an animated spin of a computer-displayed game wheel listing prizes; and
based on the spin and predetermined prize probabilities, indicating using the game wheel a prize.

19. The method of claim 18, further comprising automatically sending the prize to the employee.

20. The method of claim 18, wherein odds of winning prizes are weighted according to respective values of the prizes.
